(19) United States
(12) Patent Application Publication
(10) Pub. No.: US 2004/0123502 A1
(43) Pub. Date: Jul. 1, 2004

(54) Display device for advertisement and the like

(76) Inventor: Yukihiro Sugawara, Tokyo (JP)

Correspondence Address: Yukihiro Sugawara, #305, 21-8, Komagome 3-chome, Bunkyo-ku, Tokyo, 113-0021, JP

(21) Appl. No.: 10/330,265

(22) Filed: Dec. 30, 2002

(51) Int. Cl. G09F 11/02

(52) U.S. Cl. 40/473

(57) ABSTRACT

A display device comprises a display device member attached detachably a display body including one of an advertisement, photograph, mark and doll; and means for linking the rotation of the display device member in connection with the rotation of a revolving body, attaching so as to be able to act the display device member so that it can pull many people's interest efficiently and give the impression strongly in the high state of utility value when it uses for the advertisement etc., and it makes interesting and has the play heart when the photograph etc. is decorated.

### BACKGROUND OF THE INVENTION

This invention relates to a display device for advertisement and the like which can display an advertisement, photograph, a mark, etc.

Conventionally, the display device for advertisement and the like has attached the advertisement and photograph in the shelf space or the product itself fixedly.

Since it is difficult to raise attractiveness to consumers since it is attached so that it may appeal only to the customer who wants such goods. In addition, since the conventional display device contains on a frame or it is only stuck on a wall or board, it does not make it interesting and does not have the play heart even if it has decorated the photograph with the at the house etc.

### SUMMARY OF THE INVENTION

In light of the forgoing, it is an object of the invention to provide a display device that can pull many people's interest efficiently and give the impression strongly in the high state of utility value when it uses for the advertisement etc. It is another object of the invention to provide a display device that can it makes interesting and has the play heart when the photograph etc. is decorated.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is an explanation view in use showing a first embodiment of the present invention;

FIG. 2 is a front view showing a first embodiment of the present invention;

FIG. 3 is a side view showing a first embodiment of the present invention;

FIG. 4 is a plan view showing a first embodiment of the present invention;

FIG. 5 is an explanation view showing the way in which the picture is attached;

FIG. 6 is an explanation view showing the way in which the doll is attached;

FIG. 7 is an explanation view showing the way in which the flower is attached;

FIG. 8 is a front view showing a second embodiment of the present invention;

FIG. 9 is a side view showing a second embodiment of the present invention;

FIG. 10 is a front view showing a third embodiment of the present invention;

FIG. 11 is an explanation view of a display device member;

FIG. 12 is a front view showing a fourth embodiment of the present invention;

FIG. 13 is a side view showing a fourth embodiment of the present invention;

FIG. 14 is a front view showing a fifth embodiment of the present invention;

FIG. 15 is a side view showing a fifth embodiment of the present invention;

FIG. 16 is a front view showing a sixth embodiment of the present invention;

FIG. 17 is a side view showing a sixth embodiment of the present invention;

FIG. 18 is a front view showing a seventh embodiment of the present invention;

FIG. 19 is an explanation view showing an eighth embodiment of the present invention;

FIG. 20 is an explanation view showing a ninth embodiment of the present invention; and

FIG. 21 is an explanation view showing a tenth embodiment of the present invention.

### DETAILED DESCRIPTION OF THE PREFERRED EMBODIMENTS

Preferred embodiments of the present invention are described in more detail below with reference to the accompanying drawings.

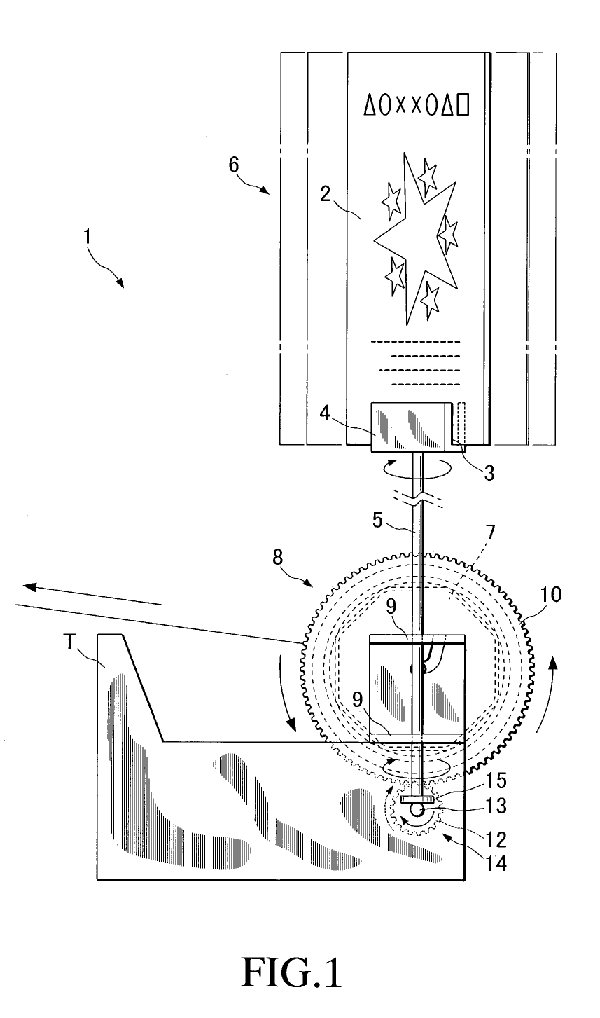

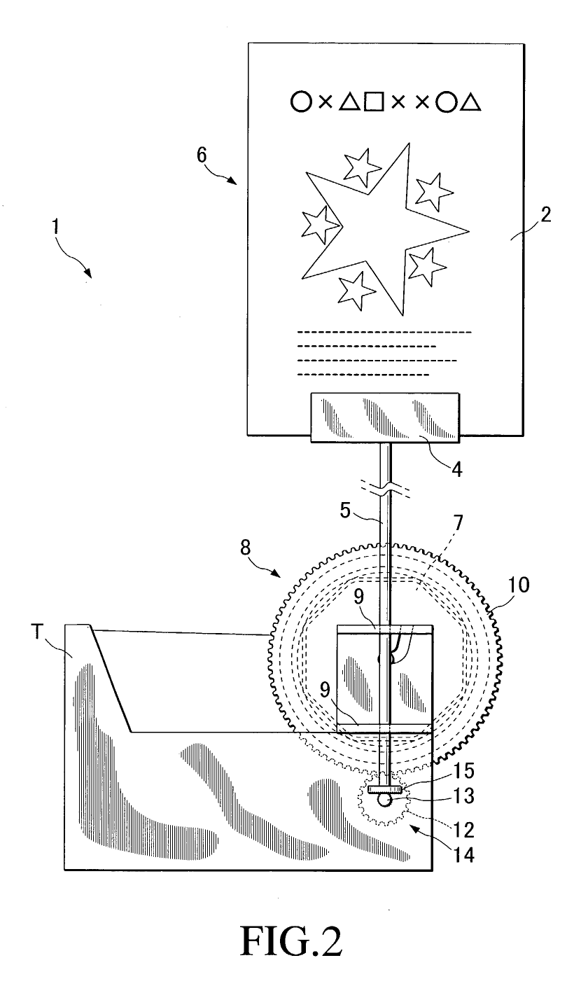

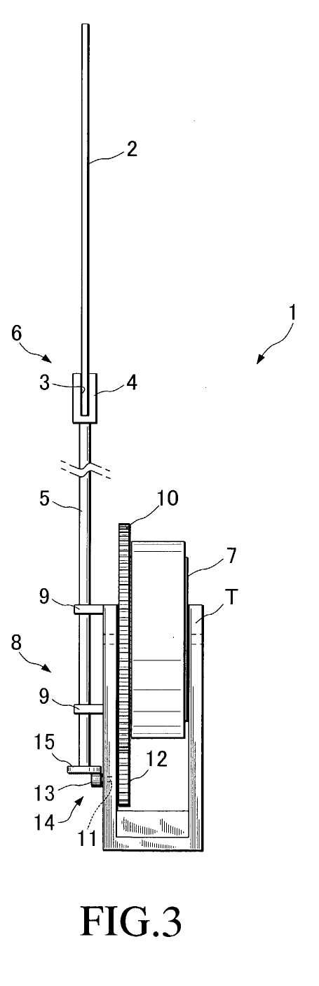

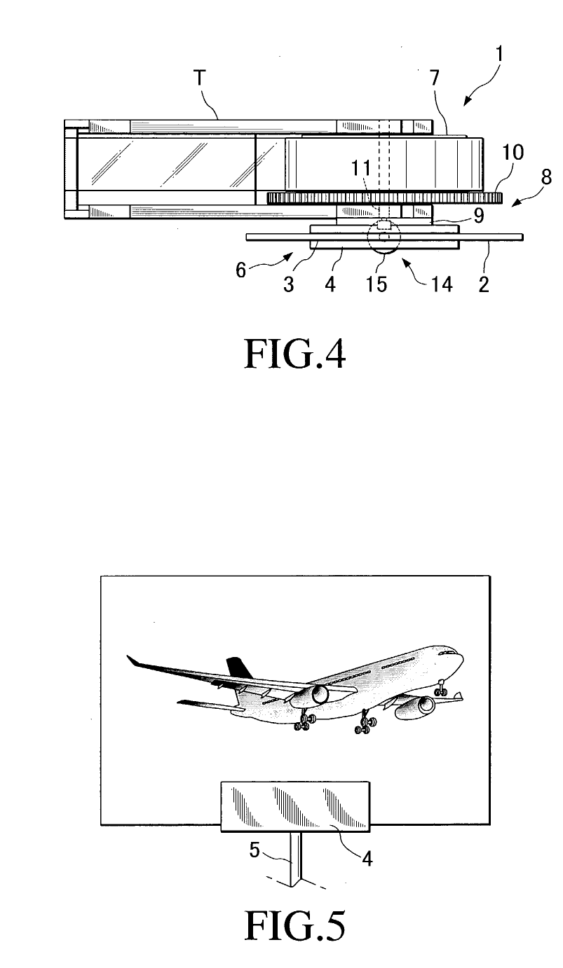

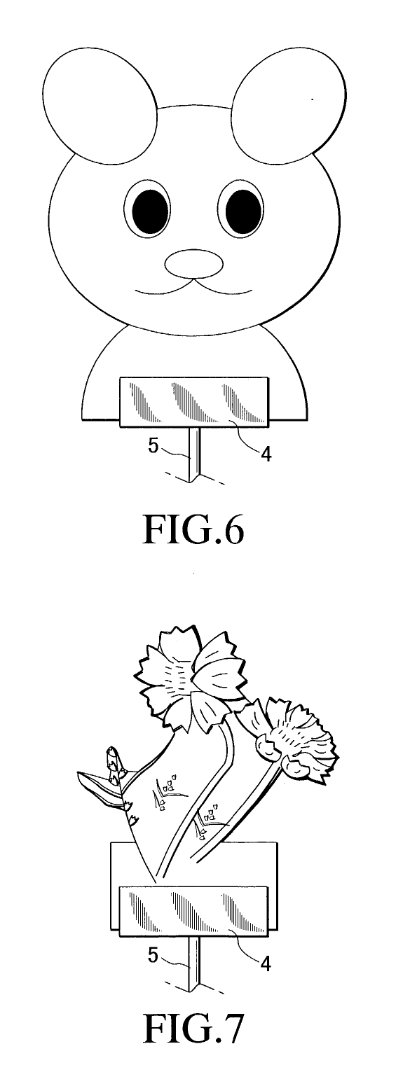

An understanding of the present invention may be best gained by reference to FIGS. 1-7. FIGS. 1-7 illustrate a winding device of (title) in accordance with a first embodiment of the present invention. Reference numeral 1 shows a display device for the advertisement, photograph, mascot doll and so on of the present invention and comprises a display device member 6 including a display body attachment part 4 having a clip part 3 which can be attached detachably a display body 2 including an advertisement, photograph and so on, the advertisement in the first embodiment of the present invention and a support part 5 made from resin material, metal material and so on, formed in the shape of a stick, supporting the display body attachment part 4; and means 8 for linking the rotation of the display device member 6 in connection with the rotation of a revolving body 7, the drum contained the tape used in a tape cutter T as usual in this embodiment, attaching so as to be able to act the display device member 6.

The support part 5 of the display device member 6 is supported by a support case 9 attached in a rear part of a tape cutter body.

The rotation linking means 8 is further comprises a gear 10 as an engaging part, formed in a side part of the drum 7 as the revolving body, having the larger diameter size than the diameter of a tape; a driving gear 14 as a driving part including a first driving gear 12 attached in the a tape cutter body through an pin 11 so as to engage the gear 10 and a second driving gear 13 attached in a tip part of the pin 11 of the first driving gear 12; and a interlocking gear 15 as a interlocking part, attaching to a lower end part of the support part 5 so that the display device member 6 is rotated horizontally by engaging the second driving gear 13

Therefore, with rotation of the drum 7 which contains the tape when the tape set to the tape cutter T is pulled out, the gear 10, the drive gear 14 and the interlocking gear 15 as a rotation linkage means rotate one by one so that the display device member 6 rotates, and the advertisement 2 attached to the display body attachment part 4 rotates.

Then, the advertisement 2 rotates whenever a salesclerk uses the tape cutter put on the potion adjacent to the cashier of a store so that many people's interest can be pulled efficiently and an impression can be strongly given about the goods carried by the advertisement.

In addition, although the display body is the advertisement 2 in this embodiment, it may be decorated the pictures, dolls, decorations formed in the form of animals and plants as illustrated in FIGS. 5-7.

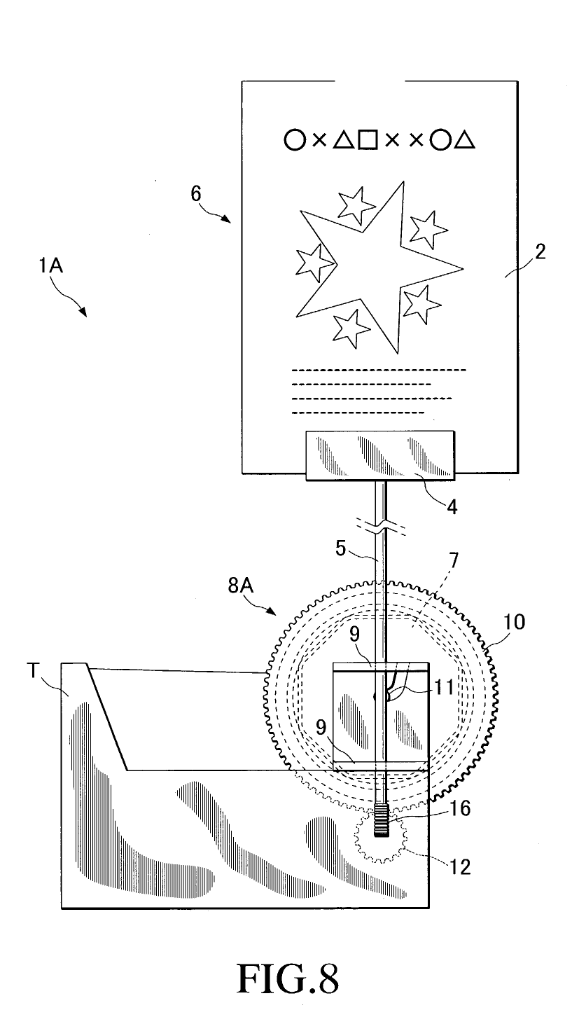

Other embodiments of the present invention will now be described with reference to FIGS. 8-21. In FIGS. 8-21, the same components as in the first embodiment described above with reference to Figs.—are designated by the same reference numerals and therefore will not be further explained in great detail.

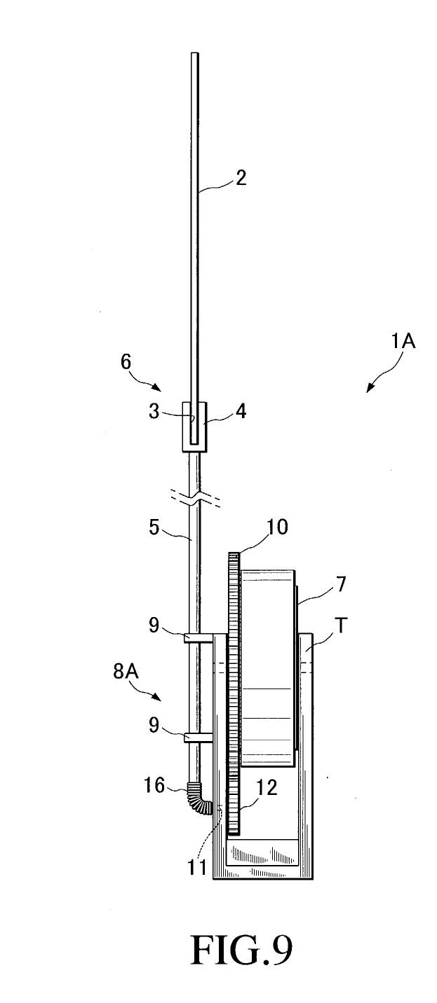

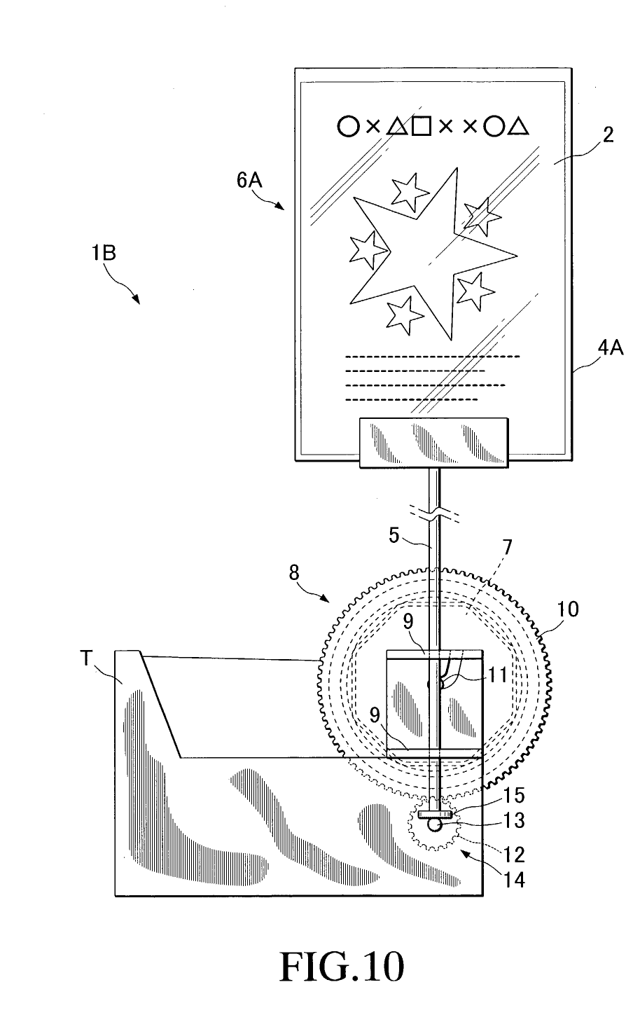

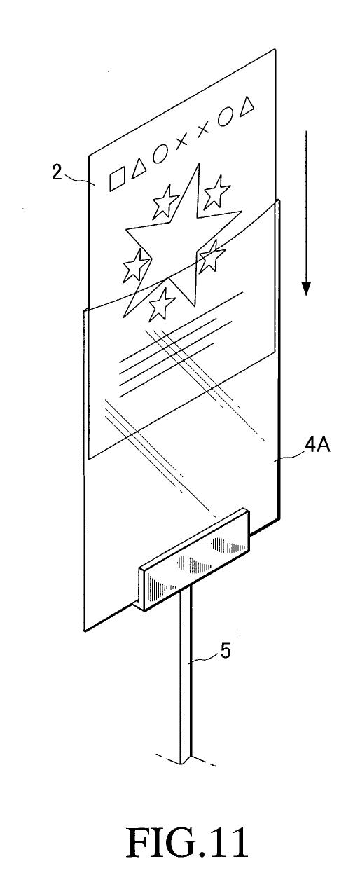

A second embodiment of the present invention is shown in FIGS. 8-9. It is distinguished from the first embodiment in that a free pipe 16 formed by the coil spring, elastic resin material, etc. having an end part thereof and another end thereof, an end part attached in a tip part of the pin 11 of the first driving gear 12 and another end attached in a lower end part of the support part 5 of the display device member 6. A display device 1A with the rotation linking means 8A according to the second embodiment has similar advantages to that according to the first embodiment A third embodiment of the present invention is shown in FIGS. 10-11. It is distinguished from the first embodiment in that a display body attachment part 4A is formed in the shape of a case, attaching detachably the advertisement thereto. A display device 1B with the display device member 6A according to the third embodiment has similar advantages to that according to the first embodiment.

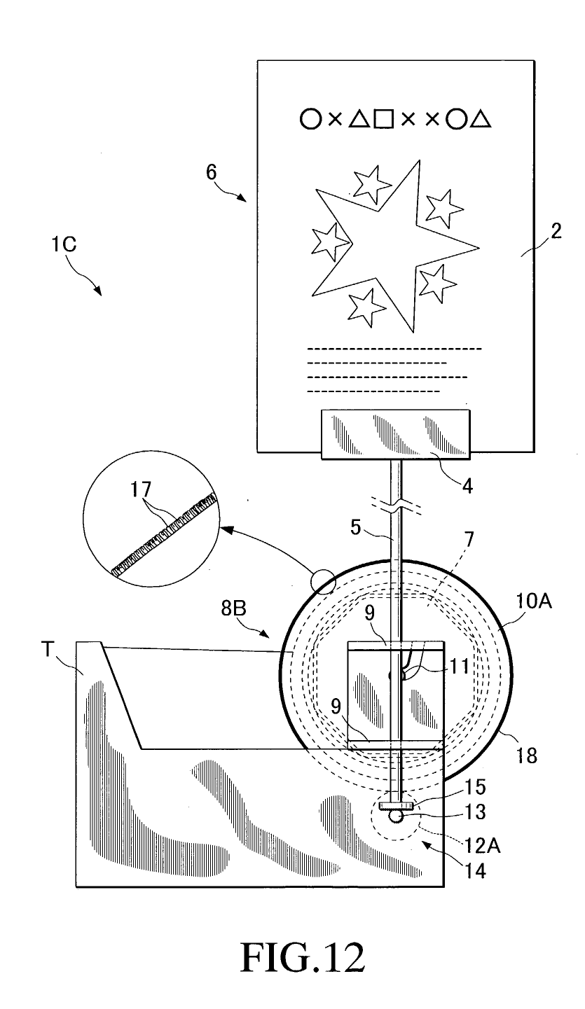

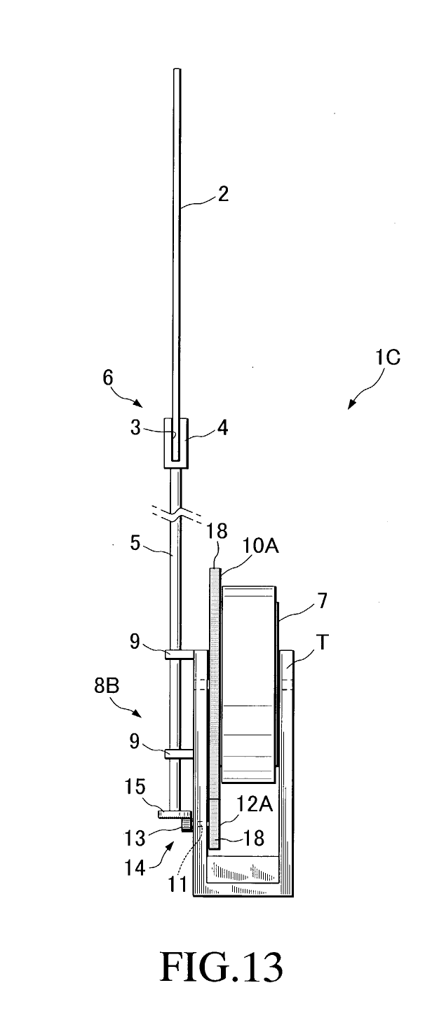

A fourth embodiment of the present invention is shown in FIGS. 12-13. It is distinguished from the first embodiment in that a gear 10A is formed a hook-and-loop fastener 18 having a plurality of projections, and a first driving gear 12A is formed the hook-and-loop fastener 18 at a surface thereof. A display device 1C with the rotation linking means 8B according to the fourth embodiment has similar advantages to that according to the first embodiment.

In addition, the first driving gear 12A may be formed in the shape of an ellipse, square, etc. which can contact with the surface part of the hook-and-loop fastener 18 when the gear 10A rotates.

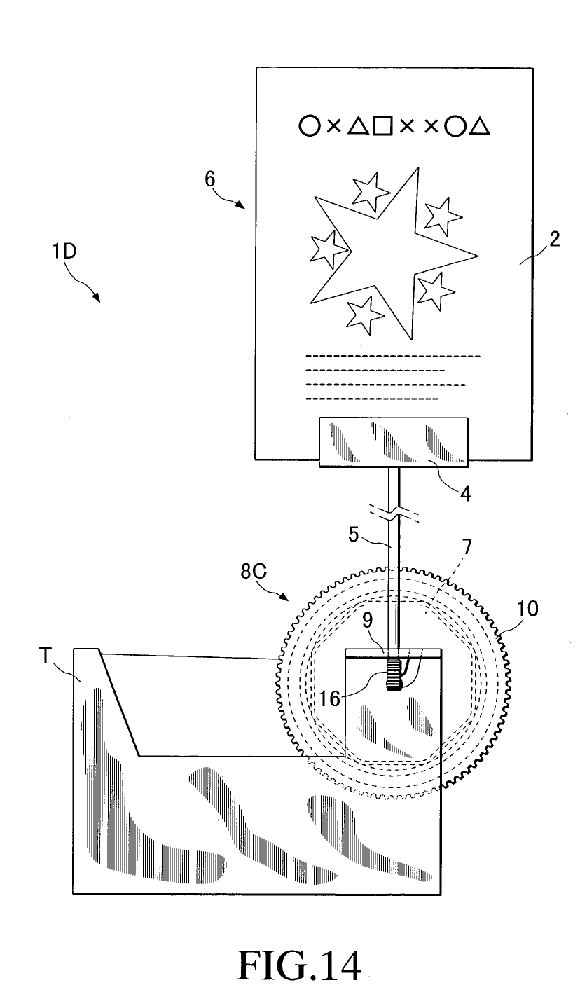

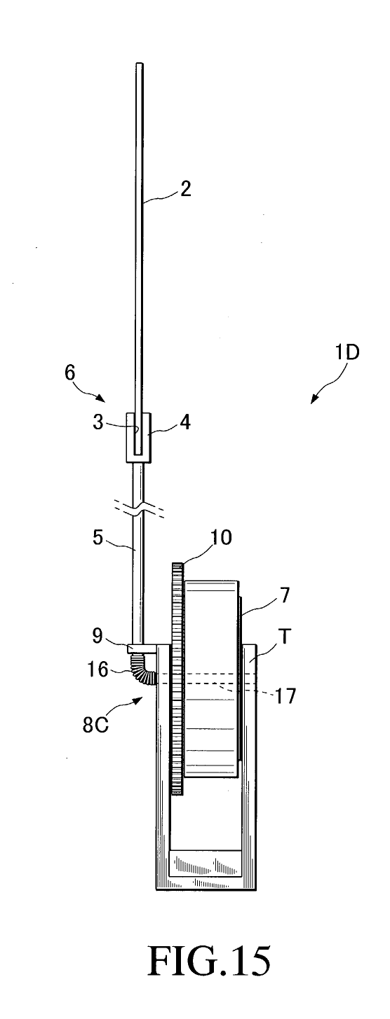

A fifth embodiment of the present invention is shown in FIGS. 14-15. It is distinguished from the second embodiment in that the free pipe 16 is attached to a support pin 19 of the drum 7 as the revolving body which contains the tape. A display device 1D with the rotation linking means 8C according to the fourth embodiment has similar advantages to that according to the first embodiment, and the support case 9 can be established so that the support part 5 can be supported according to the form of the tape cutter T, if needed

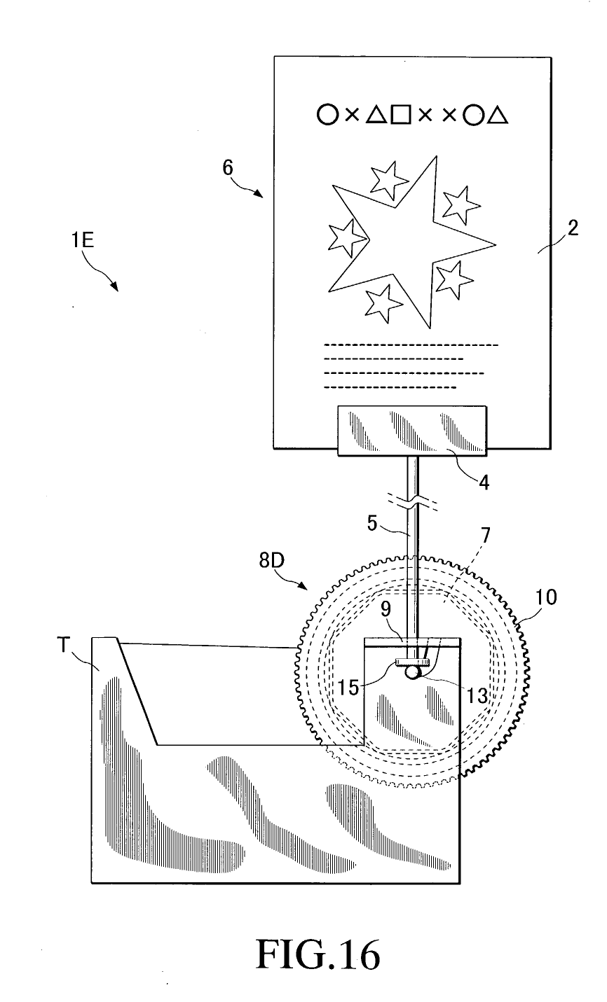

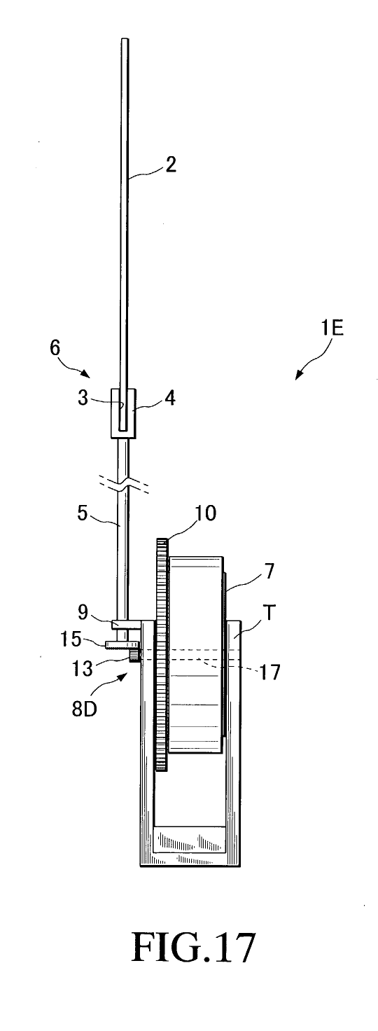

A sixth embodiment of the present invention is shown in FIGS. 16-17. It is distinguished from the second embodiment in that the second driving gear 13 is attached to the support pin 19 of the drum 7 as the revolving body which contains the tape. A display device 1E with the rotation linking means 8D according to the first embodiment has similar advantages to that according to the first embodiment and the support case 9 can be established so that the support part 5 can be supported according to the form of the tape cutter T, if needed

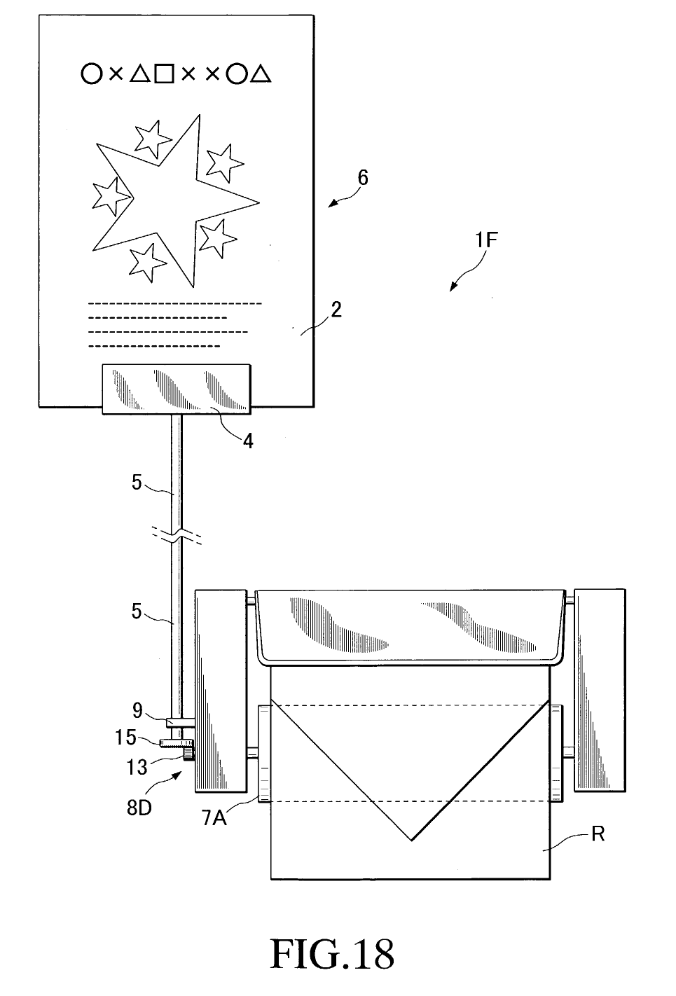

A seventh embodiment of the present invention is shown in FIG. 18. It is distinguished from the sixth embodiment in that the rotation linkage means 8D is attached to a drum 7A which contains a roll paper R installed in the toilet as usual etc. A display device 1F according to the seventh embodiment has similar advantages to that according to the sixth embodiment, and the display device member 6 rotates when the rotation linkage means 8D rotates one by one, and the photograph as a display body attached in the display body attachment part 4 etc. rotates and makes the person who watches fun.

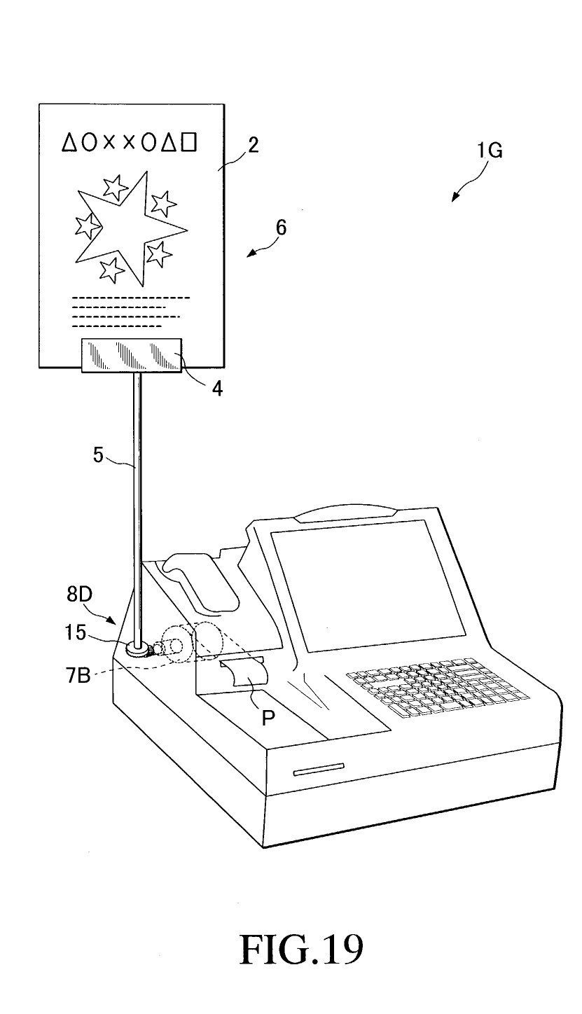

An eighth embodiment of the present invention is shown in FIG. 19. It is distinguished from the first embodiment in that the rotation linkage means 8D is attached to a drum 7B as the revolving body which contains the receipt paper P, installing in the same cashier as the former used at a store etc. A display device 1G according to the eighth embodiment has similar advantages to that according to the sixth embodiment.

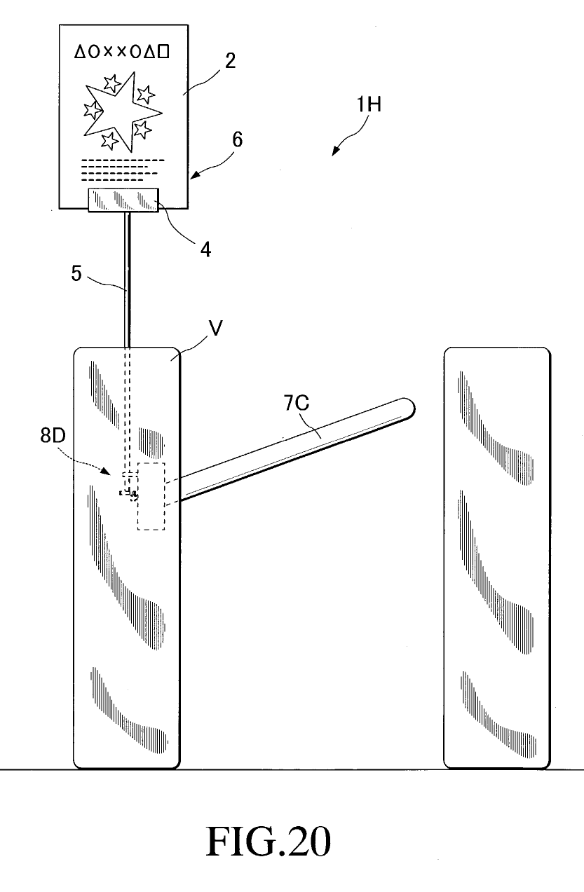

A ninth embodiment of the present invention is shown in FIG. 20. It is distinguished from the first embodiment in that the rotation linkage means 8D is attached to a count bar 7C as the revolving body which counts the number of a visitor, installed in the entrance gate V used by amusement parks including a park and zoo, theme parks, etc. A display device 1H according to the ninth embodiment has similar advantages to that according to the sixth embodiment.

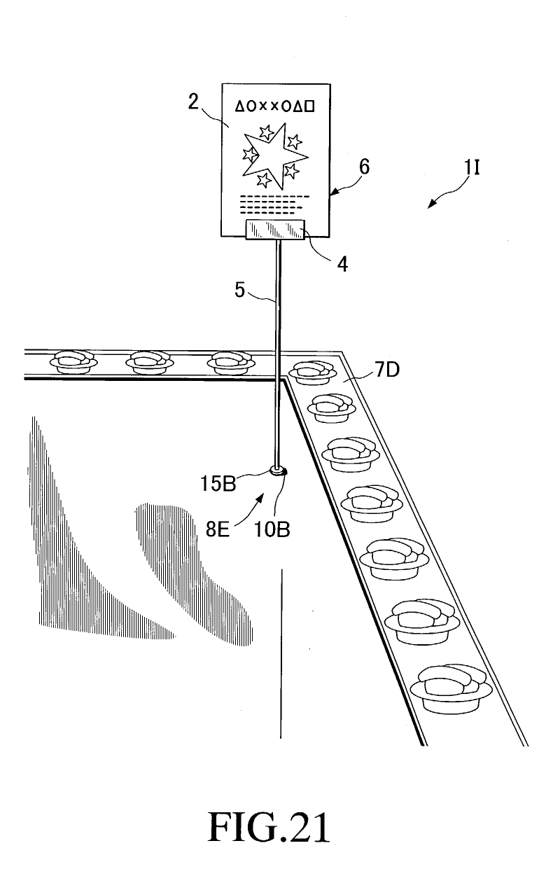

A tenth embodiment of the present invention is shown in FIG. 21. It is distinguished from the fourth embodiment in that the gear 10B as an engaging part is attached at the side part of a conveyor belt 7D as the revolving body which rotates goods including sushi, and an interlocking part 15B is attached at the support part so as to the gear 10B. A display device 1I with the rotation linking means 8E according to the tenth embodiment has similar advantages to that according to the sixth embodiment, and the conveyor belt 7D rotates always at moderate speed so that it makes the customers interesting and happy.

Furthermore, although each embodiment differs mainly explained based on the first embodiment, even if it uses the present invention combining the composition used for the form of not only this but each embodiment, the same action effect is acquired.

As set forth above, the advantages of the invention are as follows:

(1) A display device comprises a display device member attached detachably a display body including one of an advertisement photograph, mark and doll; and means for linking the rotation of the display device member in connection with the rotation of a revolving body, attaching so as to be able to act the display device member so that an advertisement, a photograph etc. can be rotated.

Therefore, it can pull many people's interest efficiently and give the impression strongly in the high state of utility value when it uses for the advertisement etc.

(2) As discussed above, when a photograph etc. is decorated, it makes interesting and it can indicate a funny style.

(3) As discussed above, it can install without spotting a design.

(4) As discussed above, since it has a simple structure, it can manufacture cheaply. Therefore, it can carry out easily.

What is claimed is:

1. Display device comprising:
a display device member attached detachably a display body including one of an advertisement, photograph, mark and doll; and
means for linking the rotation of the display device member in connection with the rotation of a revolving body, attaching so as to be able to act the display device member.

2. A display device according to claim 1, wherein the rotation linkage means further includes an engaging part attached to the revolving body; a driving part that engages with the engaging part; and an interlocking part which engages with the driving part, attaching so as to rotate the display device member.

3. A display device according to claim 1, wherein the rotation linkage means further includes a driving part which engages with the revolving body; and an interlocking part which engages with the driving part, attaching so as to rotate the display device member.

4. A display device according to claim 1, wherein the rotation linkage means further includes an engaging part attached to the revolving body; and a driving part which engages with the engaging par, attaching so as to rotate the display device member.

5. A display device according to any one of claim 1 to 5, wherein the revolving body rotates by manpower.
